(19) United States
(12) Patent Application Publication
(10) Pub. No.: US 2025/0106681 A1
(43) Pub. Date: Mar. 27, 2025

(54) APPARATUS AND METHOD FOR PROVIDING PACK DATA UNIT SET INFORMATION IN WIRELESS COMMUNICATION SYSTEM

(71) Applicant: ELECTRONICS AND TELECOMMUNICATIONS RESEARCH INSTITUTE, Daejeon (KR)

(72) Inventors: Jeoung Lak HA, Daejeon (KR); Changki Kim, Daejeon (KR)

(21) Appl. No.: 18/896,601

(22) Filed: Sep. 25, 2024

(30) Foreign Application Priority Data
Sep. 25, 2023 (KR) 10-2023-0127971
Sep. 23, 2024 (KR) 10-2024-0127948

(51) Int. Cl. H04W 28/02

(52) U.S. Cl. CPC H04W 28/0268

(57) ABSTRACT

Proposed is an apparatus and method for providing Pack Data Unit (PDU) set information in a wireless communication system. In the wireless communication system, a method for operating a User Plane Function (UPF) includes a process of transmitting PDU Set-related information and information for indicating the PDU Set-related information to a Radio Access Network (RAN) through a GTP-U extension header. The information for indicating the PDU Set-related information includes a PDU type, a QOS Flow Identifier (QFI), a PDU Set Size Indicator (PSSI), an End Data Burst Indicator (EDBI), a PDU Set Sequence Number (PSSN), and a PDU Sequence Number within a PDU Set (PSN). The PDU Set-related information includes at least one of an End PDU of the PDU Set (EPDU), an End of Data Burst (EDB), a PDU Set Importance (PSI), and a PDU Set Size (PSSize).

### TECHNOLOGY FIELD

The present disclosure generally relates to a wireless communication system. More particularly, the present disclosure relates to an apparatus and method for providing Pack Data Unit (PDU) set information in a wireless communication system.

### BACKGROUND OF THE DISCLOSURE

In a 5G system, Quality of Service (QoS) control is performed in a QoS Flow unit. However, the amount of data for multimedia communication is large, and characteristics of individual packets constituting multimedia information are also different from each other. 3GPP has defined a PDU set for efficient processing of information for XR (extended Reality), but a method of transmitting information of the PDU set has not yet been researched.

The 5G system supports a Connected mode Disconnected Reception (DRX) for reducing power consumption when a user equipment (UE) has no data to receive or transmit even during in RRC connection mode. Considering burst characteristic of data for interactive XR, a method of transmitting information of end of data burst for the DRX during a time between bursts has not yet been researched.

### CONTENT OF THE INVENTION

### The Object of the Invention

Based on the foregoing discussion, the present disclosure proposes an apparatus and method for providing Pack Data Unit (PDU) set information in a wireless communication system.

In addition, the present disclosure proposes an apparatus and method for providing PDU set information between a Radio Access Network (RAN) and a User Plane Function (UPF) in a wireless communication system.

In addition, the present disclosure proposes an apparatus and method for providing information of end of data burst between a RAN and a UPF in a wireless communication system.

In addition, the present disclosure proposes an apparatus and method for reducing power consumption in the present disclosure, a device and a method for reducing power consumption by allowing a Connected Mode DRX to be realized between a RAN and a UPF in a wireless communication system.

### Technical Object of the Invention

According to various embodiments of the present disclosure, there is provided a method for operating a User Plane Function (UPF) in a wireless communication system, the method including a process of transmitting Packet Data Unit (PDU) Set-related information and information for indicating the PDU Set-related information to a Radio Access Network (RAN) through a GTP-U extension header. The information for indicating the PDU Set-related information may include a PDU type, a QoS Flow Identifier (QFI), a PDU Set Size Indicator (PSSI), an End Data Burst Indicator (EDBI), a PDU Set Sequence Number (PSSN), and a PDU Sequence Number within a PDU Set (PSN). The PDU Set-related information may include at least one of an End PDU of the PDU Set (EPDU), an End of Data Burst (EDB), a PDU Set Importance (PSI), and a PDU Set Size (PSSize).

According to various embodiments of the present disclosure, there is provided an apparatus for operating a User Plane Function (UPF) in a wireless communication system, the apparatus including: a transceiver; and a controller connected to the transceiver such that the controller is capable of being operated with the transceiver. The controller may be configured to transmit Pack Data Unit Set-related information and information for indicating the PDU Set-related information to a Radio Access Network (RAN) through a GTP-U extension header. The information for indicating the PDU Set-related information may include a PDU type, a QoS Flow Identifier (QFI), a PDU Set Size Indicator (PSSI), an End Data Burst Indicator (EDBI), a PDU Set Sequence Number (PSSN), and a PDU Sequence Number within a PDU Set (PSN). The PDU Set-related information may include at least one of an End PDU of the PDU Set (EPDU), an End of Data Burst (EDB), a PDU Set Importance (PSI), and a PDU Set Size (PSSize).

### Effect of the Invention

In the apparatus and method according to various embodiments of the present disclosure, a PDU set is capable of being efficiently processed by receiving information about the PDU set.

In addition, in the apparatus and method according to the present disclosure, power various embodiments of consumption reduction through the Connected Mode DRX is capable of being realized by receiving information about end of data burst.

The effects that can be obtained from the present disclosure are not limited to the above-mentioned effects, and other effects not mentioned herein will be clearly understood by those skilled in the art from the following description.

### BRIEF DESCRIPTION OF THE DRAWINGS

FIG. 1 is a view illustrating an example of a 5G system network structure according to various embodiments of the present disclosure.

FIG. 2 is a view illustrating another example of the 5G system network structure according to an embodiment of the present disclosure.

FIGS. 3 are views illustrating a Connected Mode DRX (C-DRX) according to an embodiment of the present disclosure.

FIG. 4 is a view illustrating an example of video segmentation according to an embodiment of the present disclosure.

FIG. 5 is a view illustrating another example of video segmentation according to an embodiment of the present disclosure.

FIG. 6 is a view illustrating a still another example of video segmentation according to an embodiment of the present disclosure.

FIG. 7 is a view illustrating an example of PDU Sets according to an embodiment of the present disclosure.

FIG. 8 is a signal flow diagram illustrating QoS-related information of a PDU Set according to an embodiment of the present disclosure.

FIG. 9 is a view illustrating an example of information related to PDU Sets according to an embodiment of the present

FIG. 10 is a view illustrating an example of a GTP-U header configuration according to an embodiment of the present

FIG. 11 is a view illustrating an example of an extension header of a GTP-U according to an embodiment of the present disclosure.

FIG. 12 is a view illustrating an example of a downlink protocol in a PDU Session User Plane Protocol for transmitting information about a PDU session according to an embodiment of the present disclosure.

FIG. 13 is a view illustrating an example of an uplink protocol in a PDU Session User Plane protocol for transmitting information about a PDU session according to an embodiment of the present disclosure.

FIG. 14 is a view illustrating an example of extending a PDU Session User Plane Protocol, which is an example for transmitting downlink PDU Set-related information, according to an embodiment of the present disclosure.

FIG. 15 is a view illustrating an example of extending a PDU Session User Plane Protocol, which is an example for transmitting uplink PDU Set-related information, according to an embodiment of the present disclosure.

FIG. 16 is a view illustrating an example of a downlink header of a Service Data Adaptation Protocol (SDAP) for a data PDU from a RAN to a UE according to an embodiment of the present disclosure.

FIG. 17 is a view illustrating an example of an uplink header of an SDAP for a data PDU from a UE to a RAN according to an embodiment of the present disclosure.

FIG. 18 is a view illustrating an example of extending a SDAP, which is an example for transmitting downlink PDU Set-related information, according to an embodiment of the present disclosure.

FIG. 19 is a view illustrating an example of extending a SDAP, which is an example for transmitting uplink PDU Set-related information, according to an embodiment of the present disclosure.

FIG. 20 is a view illustrating an example of a Packet Data Convergence Protocol (PDCP) for a data PDU between a RAN and a UE according to an embodiment of the present disclosure.

FIG. 21 is a view illustrating an example of extending a PDCP, which is an example for transmitting PDU Set-related information, according to an embodiment of the present disclosure.

FIG. 22 is a view illustrating an example of a PDU set receiving process according to an embodiment of the present

FIG. 23 is a view illustrating a configuration of an apparatus according to various embodiments of the present disclosure.

### DETAILED DESCRIPTION OF THE EMBODIMENTS

Terms used in the present disclosure are for the purpose of describing particular embodiments only and are not intended to limit other embodiments. A singular expression may include a plural expression unless there is a contextually distinctive difference. Unless otherwise defined, all terms including technical and scientific terms used herein have the same meaning as commonly understood by those ordinarily skilled in the art corresponding to the present disclosure. It will be further understood that terms, such as those defined in commonly used dictionaries, should be interpreted as having a meaning that is consistent with their meaning in the context of the relevant art, and will not be interpreted in an idealized or overly formal sense unless expressly so defined herein. Optionally, the terms defined in the present disclosure should not be interpreted to exclude the embodiments of the present disclosure.

A hardware-based approach is described for example in an embodiment of the present disclosure described hereinafter.

However, since one or more embodiments of the present disclosure include a technique in which hardware and software are both used, a software-based approach is not excluded in the embodiments of the present disclosure.

In addition, in the detailed description and claims of the present disclosure, “at least one of A, B, and C” may mean “only A”, “only B”, “only C”, or “any combination of A, B, and C”. In addition, “at least one A, B, or C” or “at least one of A, B, and/or C” may mean “at least one of A, B, and C”.

Hereinafter, the present disclosure relates to an apparatus and method for providing Pack Data Unit (PDU) set information in a wireless communication system. Specifically, in the present disclosure, by receiving information about a PDU set in the wireless communication system, the PDU set is capable of being efficiently processed.

In addition, in the apparatus and method according to various embodiments of the present disclosure, by receiving information about end of data burst, power reduction through a Connected Mode DRX is capable of being realized.

As used in the following description, the terms referring to a signal, the terms referring to a channel, the terms referring to control information, the terms referring to a network entity, the terms referring to components of an apparatus, and so on are only illustrated for convenience of description in the present disclosure. Therefore, the present disclosure is not limited to those terms described below, and other terms having the same or equivalent technical meaning may be used therefor.

In addition, the present disclosure describes various embodiments using terms used in some communication standards (for example: 3rd Generation Partnership Project (3GPP)), but these are only of an example for explanation. The various embodiments of the present disclosure may be easily modified even in other communication systems and applied thereto.

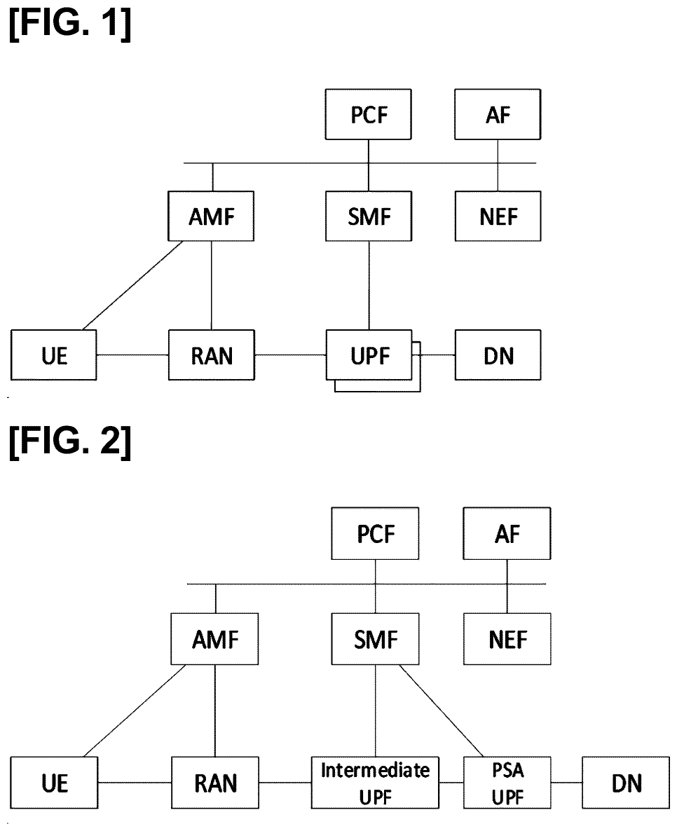

FIG. 1 is a view illustrating an example of a 5G system network structure according to various embodiments of the present disclosure.

Referring to FIG. 1, an Application function (AF), a Network Exposure Function (NEF), a Policy Control Function (PCF), a Session Management Function (SMF), an Access and Mobility Management Function (AMF), and so on may be function elements for controlling a 5G system.

The AF is in charge of policies for individual services and transmits the policies to other function elements, such as transmitting through the NEF, transmitting directly to the PCF, and so on, so that the policies can influence traffic handling. The NEF provides an API of a 5G network to the outside, so that an extended service using a 5G network service is capable of being created from the outside. The PCF is in charge of a policy of a service and transmits policy information to other function elements, such as the SMF and so on, so that the policy is capable of being executed. A User Plane Function (UPF) is a function of handling user data traffic, and is capable of transmitting user traffic data between a Radio Access Network (RAN) and a Data Network (DN). The UPF and the RAN may communicate with each other on the basis of a GTP-U protocol. The UPF may transmit PDU Set-related information or information of end of data burst for traffic from the DN to the RAN through extension of the GTP-U. One or more UPFs may be provided between the DN and the RAN.

The RAN may transmit user traffic data to User Equipment (UE). The RAN and the UE may communicate with each other on the basis of a Service Data Application Part (SDAP) and a Packet Data Convergence Protocol (PDCP). The RAN may transmit the user traffic data received from the UPF through the GTP-U to the UE by loading the user traffic data in the SDAP/PDCP.

According to an embodiment, the RAN may be any one of a Next Generation-Radio Access Network (NG-RAN), a GSM Edge Radio Access Network (GERAN), a Universal Terrestrial Radio Access Network (UTRAN), an Evolved Universal Terrestrial Radio Access Network (E-UTRAN), a non-3GPP access network, or a non-terrestrial network.

The RAN and the UE use PDU Set-related information, so that PDU set-based QoS management is capable of being realized. Since the RAN and the UE use information related to end of data burst, power consumption reduction through the Connected Mode DRX is capable of being realized.

FIG. 2 is a view illustrating another example of the 5G system network structure according to an embodiment of the present disclosure.

Referring to FIG. 2, most of function elements in FIG. 2 are the same as the function elements in FIG. 1, but the UPF is different in FIG. 2.

A PSA UPF is a PDU Session Anchor UPF, and may be a UPF that receives traffic from the DN. An Intermediate UPF may be a UPF in charge of connection to the RAN.

The RAN and the Intermediate UPF, and the Intermediate UPF and the PSA UPF may communicate with each other on the basis of the GTP-U protocol, respectively.

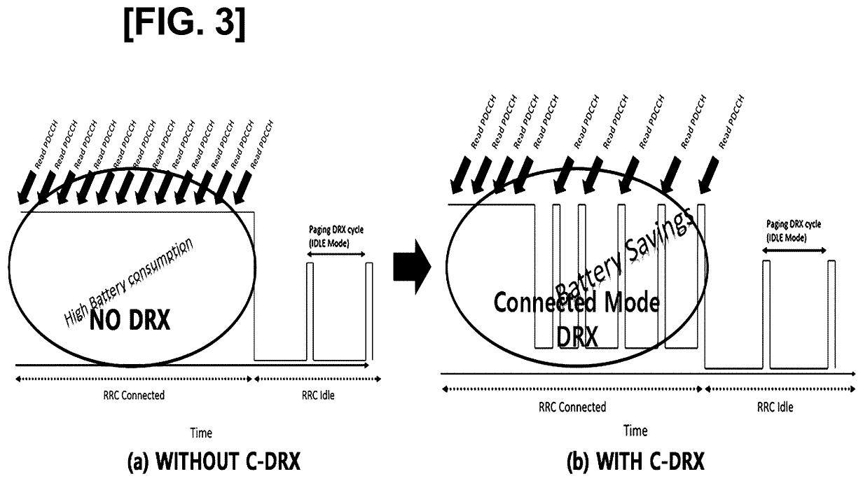

FIGS. 3 are views illustrating a Connected Mode DRX (C-DRX) according to an embodiment of the present disclosure.

Referring to FIGS. 3, (a) of FIG. 3 illustrates a method in which the C-DRX is not present, and (b) of FIG. 3 illustrates a method in which the C-DRX is present.

A method of saving a battery by using a wakeup & sleep cycle in an RRC Idle mode is called an Idle mode DRX. The C-DRX refers to a technology in which the UE uses the wakeup & sleep cycle so as to reduce battery consumption when there is no data for the UE to transmit or receive in an RRC Connected mode or when there is no data for a transceiver to transmit or receive. That is, a Physical Downlink Control Channel (PDCCH) is monitored during a wakeup period, and the monitoring is stopped during a sleep period so as to save the battery, thereby saving the battery.

According to an embodiment, the C-DRX may be applied according to whether data to the UE is present or not. To this end, End of Data Burst information of the present disclosure is provided to the RAN so that the RAN uses the End of Data Burst information for setting a timer required for the C-DRX.

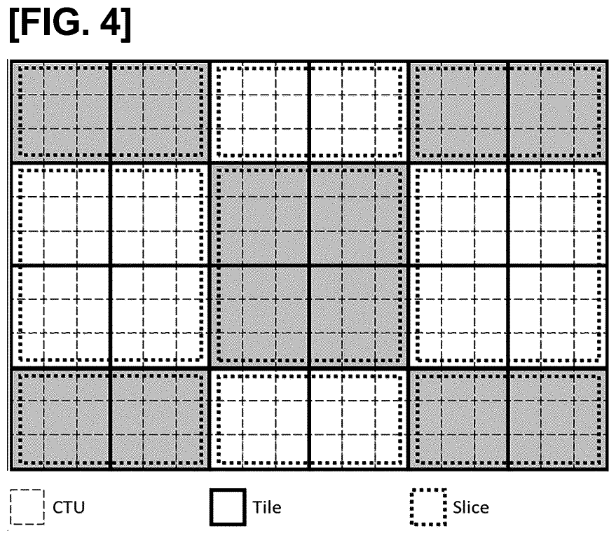

FIG. 4 is a view illustrating an example of video segmentation according to an embodiment of the present disclosure.

Referring to FIG. 4, in a video segmentation, when a video is encoded and transmitted, the video is segmented into several packets and then transmitted in order to prevent the entire or partial corruption of data due to an error on a transmission channel. At this time, a method of segmenting a video includes: i) segmenting a still image displayed on a screen, i.e., each frame of a film, into a Coding Tree Unit (CTU); ii) partitioning the frames into tiles which can be encoded and decoded in parallel processing in a CTU basis; and iii) defining a slice that can be decoded independently of an error of an adjacent slice when slice-based decoding is performed.

FIG. 4 is a view illustrating an example in which one frame is segmented into 18×12 CTUs, 24 tiles, and 9 square slices. However, an embodiment of the present disclosure is not limited to the example in FIG. 4.

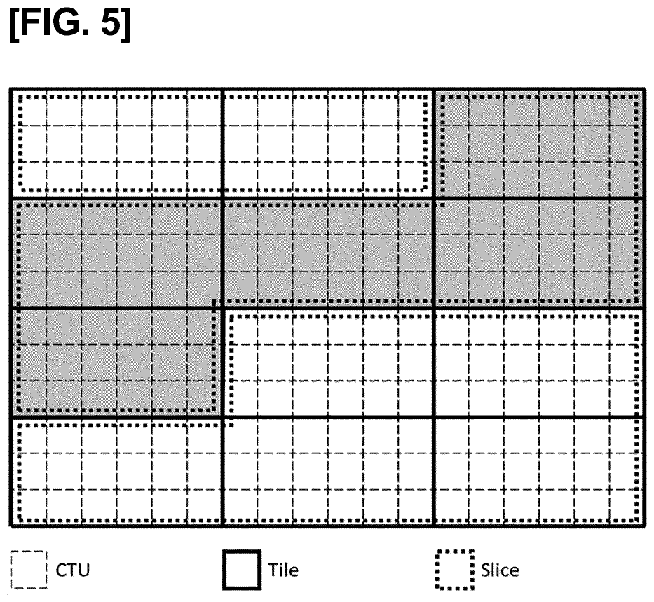

FIG. 5 is a view illustrating another example of video segmentation according to an embodiment of the present

Referring to FIG. 5, FIG. 5 is a view illustrating an example in which one frame is segmented into 18×12 CTUs, 12 tiles, and three raster-scan slices. A slice is configured in a rectangular shape in FIG. 4, but a slice in FIG. 5 is configured in a raster-scan order. A raster-scan may be a method in which a horizontal scanning line of a screen is scanned downward by one line at a time from an upper portion of the screen.

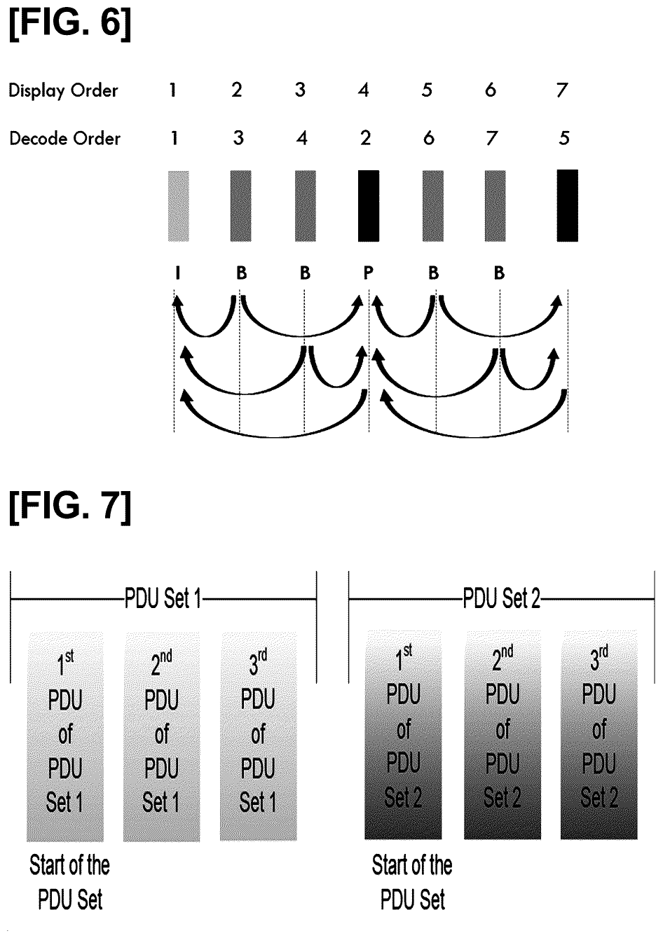

FIG. 6 is a view illustrating a still another example of video segmentation according to an embodiment of the present disclosure.

Referring to FIG. 6, in FIG. 6, frames of a video are defined as a Group of Pictures (GOP) by grouping the frames of the video into several consecutive image frames. The GOP may include an I-frame, a B-frame, and a P-frame. The I-frame does not refer to other frames, which results in lower compression efficiency but provides strong resilience to errors. The P-frame is a forward prediction frame that refers to a preceding I-frame or a preceding P-frame, and only uses data different from the preceding frame, so that the compression efficiency of the P-frame is higher than that of the I-frame. The B-frame is a bidirectional prediction frame that uses motion between preceding and subsequent frames as data, so that the compression efficiency of the B-frame is higher than that of the P-frame.

FIG. 7 is a view illustrating an example of PDU sets according to an embodiment of the present disclosure.

Referring to FIG. 7, a PDU set may be defined by at least one packet for transmitting a payload such as a video slice or a tile for multimedia traffic such as XR. Although video is used as an example in each drawing, the same concept may be applied to expressing audio or other media.

Packets within a PDU Set may be processed such that all packets belonging to the PDU Set are decoded and processed together. According to an embodiment, due to the characteristics of a PDU Set, when any one packet in the PDU Set is damaged, the entire PDU Set may become unusable.

Referring to FIG. 7, FIG. 7 is a view illustrating an example in which each of two PDU Sets is configured with three packets. For example, when any one packet in the middle of the PDU Set is damaged or is transmitted later than the time when the image is required to be output, subsequent packets after the packet may no longer be necessary to be transmitted. For example, when each PDU Set is configured for the I-frame, the B-frame, and the P-frame, respectively, the PDU Set of the I-frame is required to be processed with higher importance than that of the PDU Set of the B-frame.

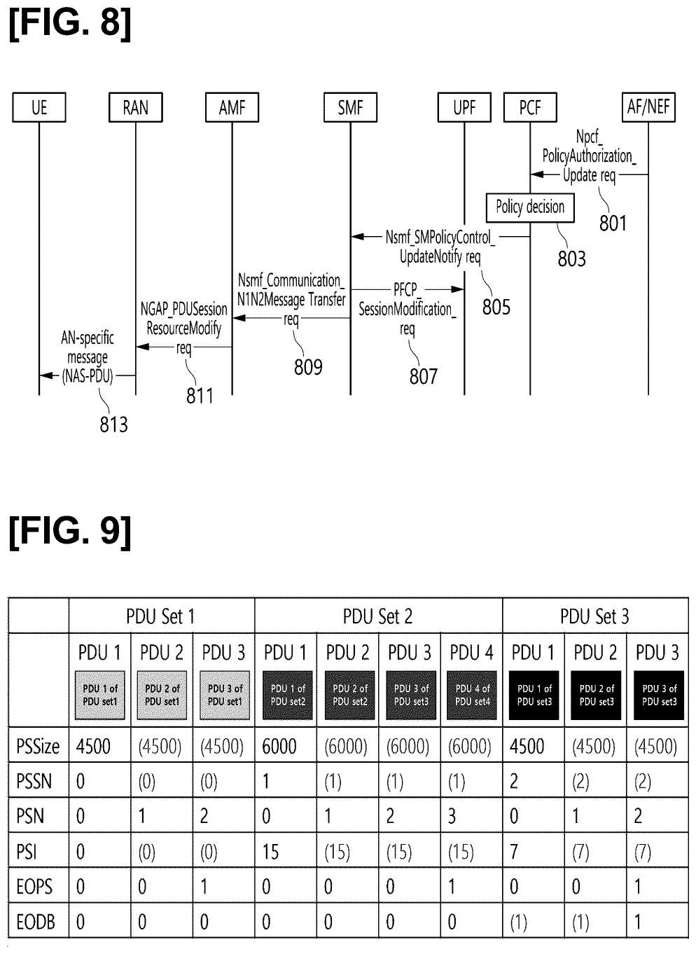

FIG. 8 is a signal flow diagram illustrating QoS-related information of a PDU set according to an embodiment of the present disclosure.

The QoS-related information of the PDU set may include a PDU Set Delay Budget (PSDB), a PDU Set Error Rate (PSER), and PDU Set Integrated Handling Information (PSIHI). According to an embodiment, the QoS-related information of the PDU set may be used differently for uplink and downlink, respectively.

The PSDB is a PDU Set Delay Budget, and may be the maximum value of the time that may be required for the PDU Set to be transmitted between the PSA UPF and the UE. For example, when the time of the PSDB is expressed as an integer n, the time may be used to mean the product (T*n) of a unit time T (for example: 0.5 ms, 0.1 ms, 0.01 ms, and so on) and n. The RAN may adjust resource scheduling for the corresponding UE according to the PSDB.

The PSER may be the maximum value of the rate of the PDU Set which is transmitted from an RLC layer at a transmitting side but which is not transmitted to a PDCP layer at a receiving side. For example, when the error rate of the PSER is expressed as a scalar(s) and exponent (e), the error rate may be calculated and used as a value of s*10^{-e}. The RAN may adjust setting for a corresponding RLC and a corresponding HARQ according to the PSER.

The PSIHI is PDU Set Integrated Handling Information, and may indicate whether all PDUs of the corresponding PDU Set are required to be received. The UE, the RAN, and the UPF may respond differently to a packet in the corresponding PDU Set with some PDUs lost or erroneous. In a situation in which the PSIHI is set, when any packet of the corresponding PDU Set is lost or an error occurs, the packet is required to be transmitted again. However, in a situation in which the PSIHI is not set, when any packet of a PDU Set is lost and an error occurs, receiving of not only the packet but also other packets of the corresponding PDU Set may be abandoned.

Referring to FIG. 8, the PCF may receive a PDU Set QoS-related parameter for a corresponding session from the AF or the NEF (801).

After authorization verification for a corresponding request is performed (803), the PCF may notify the SMF of a policy change for the corresponding session (805). Here, the PSDB, the PSER, the PSIHI, and so on are included.

According to the policy change from the PCF, the SMF may transmit a message including the PSDB, the PSER, the PSIHI, and so on to the UPF, the RAN, and the UE. Specifically, the SMF may transmit a PFCP_SesssionModification req to the UPF (807), and may transmit the message to the RAN and the UE by including the message in a Namf_Communication_N1N2MessageTransfer req (809).

A message element included in the Namf_Communicaiton_N1N2MessageTransfer req and transmitted to the RAN may include a PDUSessionResourceModify req Transfer, and a message element included in the Namf_Communicaiton_N1N2MessageTransfer req and transmitted to the UE may include a PDUSessionModification command.

According to an embodiment, the AMF may generate a message on the basis of the message element which is included in the Namf_Communicaiton N1N2MessageTransfer req and which is transmitted to the RAN.

According to an embodiment, the AMF may include the message transmitted to the UE from the SMF in another message.

The AMF may include the PDUSessionResourceModify req Transfer to the RAN, which is included in the Namf_Communicaiton_N1N2MessageTransfer req, in a PDUSessionResourceModify req message that is an NGAP message, and may transmit the PDUSessionResourceModify req Transfer to the RAN (811). In the operation 811, the AMF may include the PDUSessionModification command, which is a NAS SM message to the UE and which in the is included Namf_Communicaiton_N1N2MessageTransfer req, in a DLNASTransport that is the NAS MM message, and then include the DLNASTransport in the PDUSessionResourceModify req again that is the NGAP message, and may transmit the DLNASTransport to the RAN.

When there is no PDUSessionResourceModify req Transfer to be transmitted to the RAN in the Namf_Communicaiton_N1N2MessageTransfer req and there is only the PDUSessionModification command to the UE, the AMF may include the PDUSessionModification command in the DLNASTransport that is the NAS_MM message, and then include the DLNASTransport in a DOWNLINK NAS TRANSPORT that is the NGAP message, and may transmit the DLNASTransport to the RAN.

The RAN may transmit the DLNASTransport included in the PDUSessionResourceModify req or the DOWNLINK NAS TRANSPORT to the UE. At this time, a corresponding RRC message may be used as an AN-specific message (813).

According to an embodiment, in the process illustrated in FIG. 8, the SMF may include at least one of the PSDB, the PSER, and the PSIHI, together with a corresponding PDU Set identifier, in the PFCP SesssionModification req or a PDUSessionEstablishment req, and may transmit the request to the UPF. According to an embodiment, when the PDU Set identifier is omitted and only the PSDB, the PSER, and the PSIHI are transmitted, the PSDB, the PSER, and the PSIHI may be directly applied to the corresponding QoS flow.

According to an embodiment, in the process illustrated in FIG. 8, the SMF may include at least one of the PSDB, the PSER, and the PSIHI, together with the corresponding PDU Set identifier, in the PDUSessionResourceModify req Transfer or a PDUSessionResourceSetup req Transfer, and may transmit the request transfer to the RAN via the AMF. According to an embodiment, when the PDU Set identifier is omitted and only the PSDB, the PSER, and the PSIHI are transmitted, the PSDB, the PSER, and the PSIHI may be directly applied to the corresponding QoS flow.

In the procedure illustrated in FIG. 8, the SMF may include at least one of the PSDB, the PSER, and the PSIHI, together with the corresponding PDU Set identifier, in the PDUSessionModification command or the PDUSessionEstablishment req, and may transmit the command or the request to the UE via the AMF/RAN. According to an embodiment, when the PDU Set identifier is omitted and only the PSDB, the PSER, and the PSIHI are transmitted, the PSDB, the PSER, and the PSIHI may be directly applied to the corresponding QoS flow.

FIG. 9 is a view illustrating an example of information related to PDU sets according to an embodiment of the present disclosure.

Referring to FIG. 9, PDU Set-related information required for each PDU belonging to each PDU Set may include a PDU Set Size (PSSize), a PDU Set Sequence Number (PSSN), a PDU Sequence Number within a PDU Set (PSN), a PDU Set Importance (PSI), an Indication of End PDU of the PDU Set (E), and an End of Data Burst (EODB).

The PDU Set Size (PSSize) represents the sum of sizes of PDUs belonging to one PDU Set in bytes, may be indicated for each PDU belonging to the PDU Set or may be indicated for only a specific PDU (for example, a first PDU of the corresponding PDU Set). According to an embodiment, when the size of the PDU Set is unknown or the size value is not provided, zero may be used for the PSSize, or the PSSize may be omitted.

According to an embodiment, after whether the PSSize is included or not is indicated by using a PDU Set Size Exist (PSSizeE), the size of the PDU Set may be indicated when there is the PSSize, and the size of the PDU Set may not be indicated when there is no PSSize.

The PDU Set Sequence Number (PSSN) is a sequence number of a corresponding PDU Set in the traffic flow, and the sequence number is rolled-over from zero to a specific value (for example: 1023). The PSSN may be indicated for all PDUs belonging to the PDU Set, or may be indicated only for a specific PDU (for example, a first PDU of the corresponding PDU Set). According to an embodiment, the PSSN may indicate the order of the PDU Sets in the data flow, and the order between the PDU Sets may be managed and processed according to the PSSN. The PSSN may serve as a PDU Set identifier.

The PDU Sequence Number within a PDU Set (PSN) is a sequence number of a corresponding PDU within the PDU Set, and the sequence number is rolled-over from zero to a specific value (for example: the number of PDUs within the corresponding PDU Set minus one). At this time, the PSN is indicated for each PDU. According to an embodiment, the UPF, the UE and the RAN may sequentially manage and process the PDUs in the PDU Set according to the PSN.

The PDU Set Importance (PSI) indicates a relative importance of the corresponding PDU Set compared to other PDU Sets in the traffic flow, the relative importance may be expressed as a value from zero to 15. For example, a smaller value may indicate higher importance. The PSI may be indicated for each PDU belonging to the PDU Set, or may be indicated only for a specific PDU (for example, a first PDU of the corresponding PDU Set).

The Indication of End PDU of the PDU Set (E) indicates whether a corresponding PDU is the last PDU within a corresponding PDU Set. The Indication of End PDU of the PDU Set (E) may be indicated for each PDU belonging to the PDU Set, or may be indicated only for the last PDU. The Indication of End PDU of the PDU Set (E) may be used in the same meaning as an End of PDU Set (EPDU).

The Indication of End PDU of the PDU Set (E) and the EPDU may be used for QoS-based traffic processing for the QoS flow in addition to PDU Set-based QoS control for the PDU Set. In addition, the PDU Set-based QoS control for the corresponding PDU Set may be performed on the basis of the PDU Set Delay Budget (PSDB), the PDU Set Error Rate (PSER), and the PDU Set Integrated Handling Information (PSIHI).

According to an embodiment, all PDUs belonging to a PDU Set may be controlled so that the PDUs are transmitted between the UPF and the UE within the time specified in the PSDB.

In addition, according to an embodiment, for all PDUs belonging to a PDU Set, a ratio of loss between the RAN and the UE may be controlled so that the ratio of loss is equal to or less than the PSER.

In addition, according to an embodiment, the Indication of End PDU of a PDU Set (E) and the EPDU may be used to check whether all PDUs belonging to the PDU Set have been received or whether some errors have occurred.

In addition, according to an embodiment, the Indication of End PDU of the PDU Set (E) and the EPDU may be used to check whether there are no more PDUs in the corresponding PDU Set for calculating the PSDB and the PSER.

In addition, according to an embodiment, the Indication of End PDU of the PDU Set (E) and the EPDU may be used to check whether no more PDUs in the corresponding PDU Set are required to be received according to the PSIHI.

In addition, according to an embodiment, all PDUS belonging to one PDU Set may be transmitted in the same QoS flow.

The End of Data Burst (EODB) indicates the completion of one or more burst PDU Sets in a single segment. The EODB may be indicated for all PDUs of the last PDU Set among the PDU Sets in the single segment, or may be indicated only for a specific PDU (for example, the last PDU in the last PDU Set). The EODB may be used in the same meaning as an End of Data Burst (EDB).

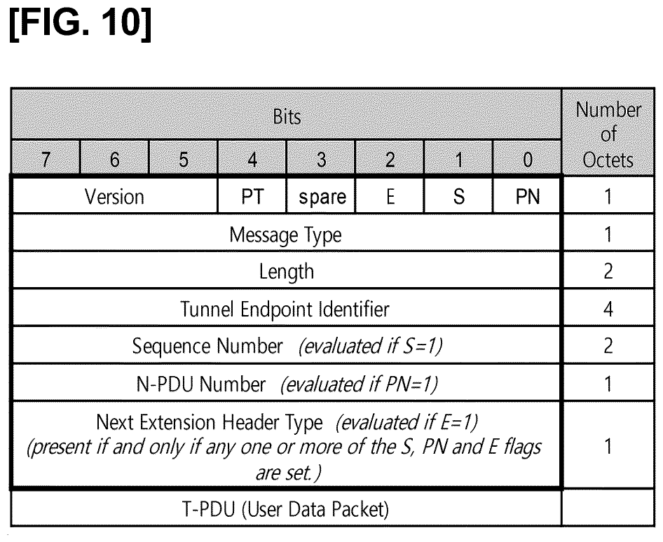

FIG. 10 is a view illustrating an example of a GTP-U header configuration according to an embodiment of the present

Referring to FIG. 10, a GTP-U may be composed of a header and a T-PDU that is user data. In header information, a version may be a version of a corresponding GTP protocol. A PT is a protocol type, and the PT may distinguish between a GTP (value 1) and a GTP′ (value 0). An E is an extension header flag, and may indicate the presence of a Next Extension Header Type field. An S is a sequence number flag, and may indicate the presence of a Sequence Number field. A PN is an N-PDU number flag, and may indicate whether an N-PDU Number field is present. A Message Type indicates the type of GTP message. The presence or absence of the T-PDU may be determined according to the Message Type. A Length is a payload length in bytes, and may be indicated by subtracting a mandatory 8-byte field from the total length. A Tunnel Endpoint Identifier may indicate an identifier that multiplexes a GTP tunnel. The Sequence Number may indicate a serial number for the T-PDU. The N-PDU number is used in a process such as an Inter SGSN Routing Area Update process, and may be used differently according to a scenario. A Next Extension Header Type may indicate the type of extension header to be used in place of the T-PDU.

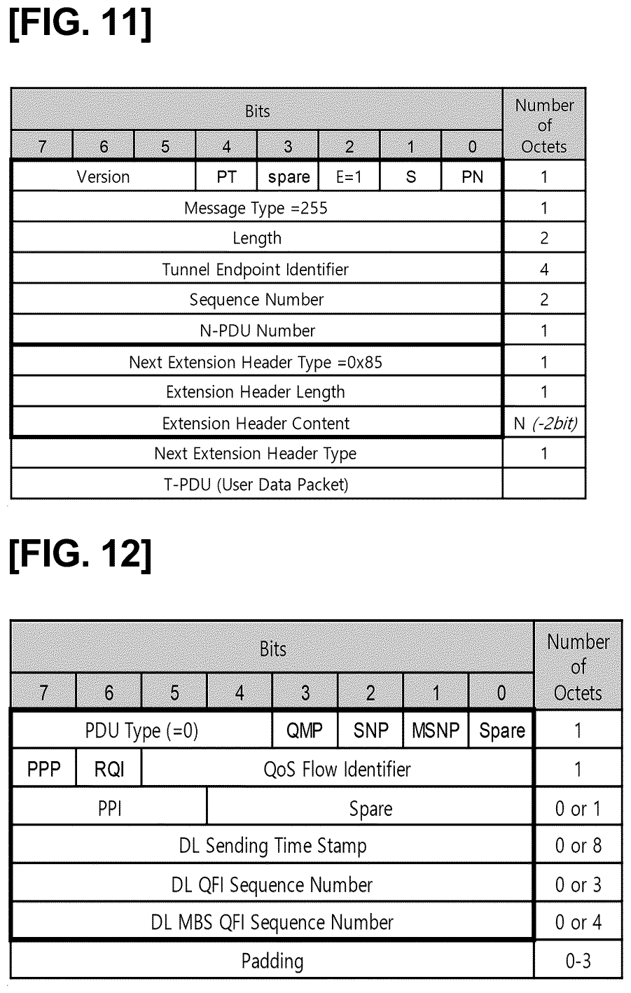

FIG. 11 is a view illustrating an example of an extension header of a GTP-U according to an embodiment of the present disclosure.

Referring to FIG. 11, in FIG. 11, an example in which the GTP-U header is extended and used is illustrated. When the GTP-U header is extended, setting the Message Type to 255 may indicate that the T-PDU follows the GTP-U header. After the E, which is the extension header is set to 1, a Next Extension Header may be added. A Next Extension Header Type indicates the type of Extension Header Content. When the Next Extension Header Type is 0x85, it may be indicated that the Extension Header Content is a PDU Session container. An Extension Header Length may indicate the length of the Extension Header in 4-byte units. The Extension Header Content may be determined by the Next Extension Header Type.

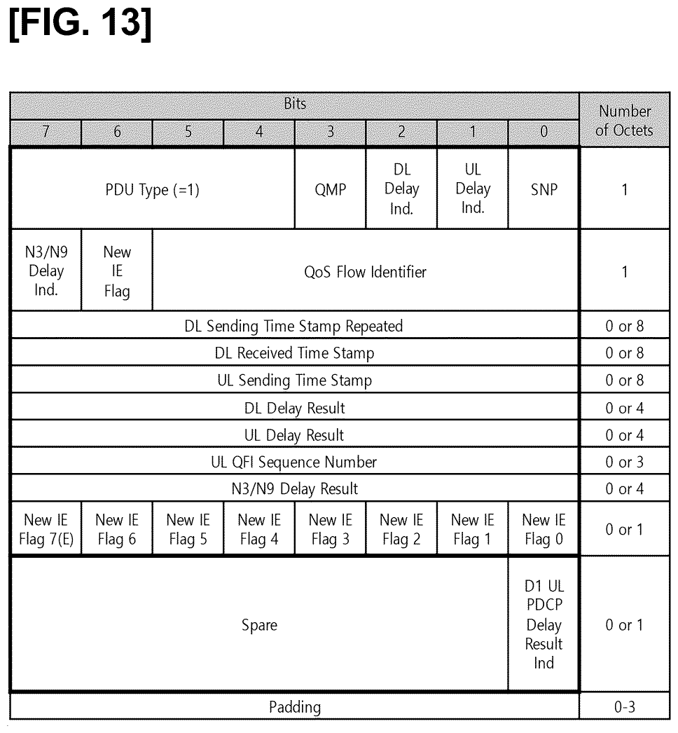

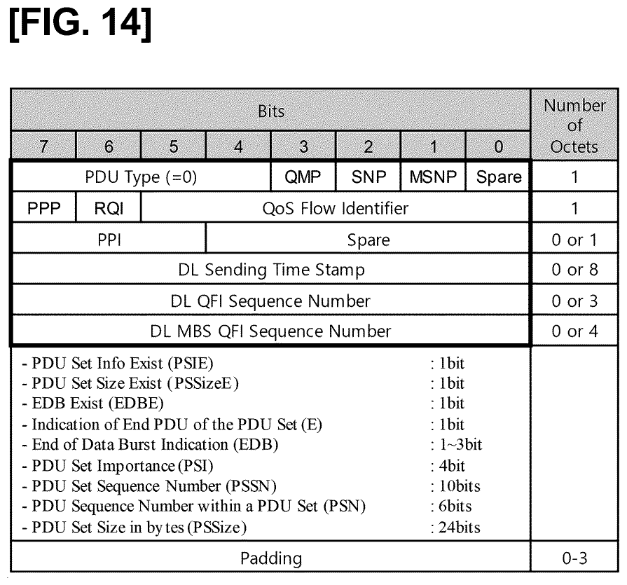

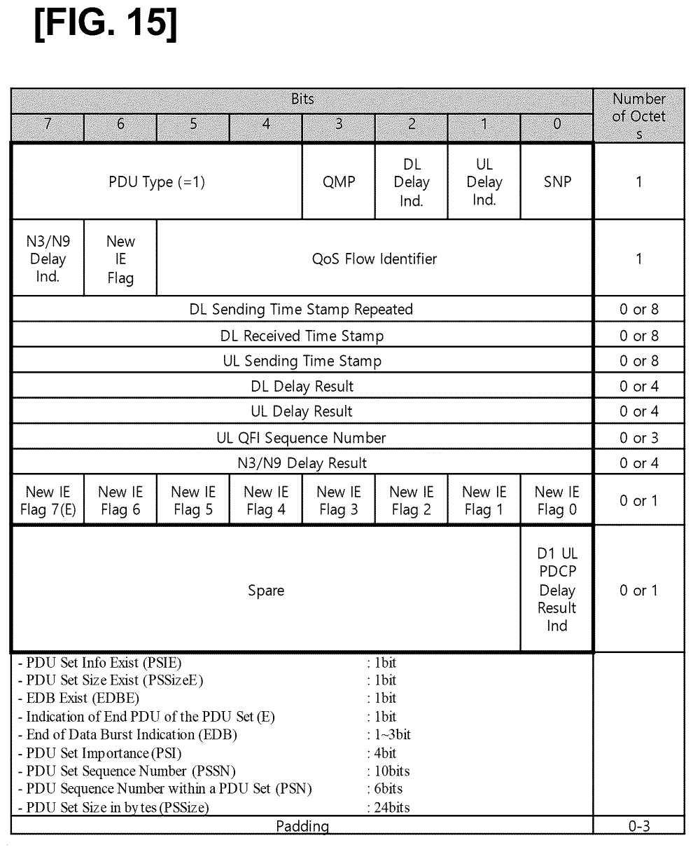

For example, when the Next Extension Header Type is 0x85, the Extension Header Content is the PDU Session Container, and may include protocols in FIG. 12, FIG. 13, FIG. 14, and FIG. 15. At this time, the length may be configured such that the number of bytes of the length of the corresponding Next Extension Header is a multiple of four. Later, additional Next Extension Header may be added. When there is no Next Extension Header, the Next Extension Header Type may be set to zero.

According to an embodiment, another extension header may be added or still another extension header may be added after the PDU Session container by changing a value of the Next Extension Header Type.

FIG. 12 is a view illustrating an example of a downlink protocol in a PDU Session User Plane Protocol for transmitting information about a PDU session according to an embodiment of the present disclosure.

Referring to FIG. 12, a PDU Type may indicate uplink or downlink, and the downlink may be indicated with a value of zero. That is, the PDU Type indicates a structure of a PDU, and may indicate different structures according to the uplink and the downlink. That is, according to an embodiment, an uplink PDU and a downlink PDU may have different structures.

A QMP is a QoS Monitoring Packet, and may indicate the presence of a DL Sending Time Stamp. The DL Sending time Stamp may indicate the time when the UPF receives a corresponding packet. An SNP is a Sequence Number Presence, and may indicate the presence of a DL QFI Sequence Number. The DL QFI sequence number may indicate a serial number of a corresponding T-PDU in a corresponding QoS flow. An MSNP is an MBS Sequence Number Presence, and may indicate the presence of a DL MBS QFI Sequence Number. The DL MBS QFI sequence number may indicate a serial number of a corresponding T-PDU in a corresponding MBS QoS flow. A PPP is a Paging Policy Presence, and may indicate the presence of a Paging Policy Indicator. The Paging Policy Indicator may indicate a paging policy. An RQI is a Reflective QoS Indicator, and may instruct the UE on whether to perform a Reflective QoS Activation. A QoS Flow Identifier may indicate the QoS flow to which the T-PDU belongs. A Padding may be added such that the overall length of the PDU Session User Plane Protocol is a multiple of four.

FIG. 13 is a view illustrating an example of an uplink protocol in a PDU Session User Plane protocol for transmitting information about a PDU session according to an embodiment of the present disclosure.

Referring to FIG. 13, a PDU type may indicate uplink or downlink, and a structure corresponding to the uplink may be indicated with a value of one. A QMP is a QoS Monitoring Packet, and may indicate the presence of a DL Sending Time Stamp Repeated, a DL Receiving Time Stamp, and a UL Sending Time Stamp. The DL Sending Time Stamp Repeated may be a DL Sending Time Stamp value that the RAN receives from the UPF. The DL Receiving time stamp may be the time when the RAN receives a packet of a downlink PDU Session User Plane Protocol having the DL Sending time Stamp value. The UL Sending time Stamp may indicate the time when the RAN transmits a corresponding packet. A DL Delay Ind is a DL Delay Indicator, and may indicate the presence of a DL Delay Result. The DL Delay Result may indicate a delay time from the RAN to the UE. A UL Delay Ind is a UL Delay Indicator, and may indicate the presence of a UL Delay Result. The UL Delay result may indicate a delay time from the UE to the RAN. An SNP is a Sequence Number Presence, and may indicate the presence of a UL QFI Sequence Number. The UL QFI Sequence Number may indicate a serial number of a corresponding T-PDU in a corresponding QoS flow. An N3/N9 Delay Ind is an N3/N9 Delay Indicator, and may indicate the presence of an N3/N9 Delay Result. The N3/N9 Delay Result may be a sum value of N3/N9 packet delay times. A New IE Flag may indicate the presence of a New IE Flag 0 to a New IE Flag 7. The New IE Flag 0 may indicate the presence of a D1 UL PDCP Delay Result. The New IE Flag 1 to the New IE Flag 6 may be Spares. The New IE Flag 7 may be used when an extension is performed so as to add a new information element. The D1 UL PDCP Delay Result Ind may indicate that a UL Packet Average Delay is included in the UL Delay result. A QoS Flow Identifier may indicate the QoS flow to which the T-PDU belongs. A Padding may be added such that the overall length of the PDU Session User Plane Protocol is a multiple of four.

FIG. 14 is a view illustrating an example of extending a PDU Session User Plane Protocol, which is an example for transmitting downlink PDU Set-related information, according to an embodiment of the present disclosure.

Referring to FIG. 14, added PDU Set-related information may further include one or more of following information elements, and these information elements may be added before a Padding, or an existing Spare may be used. The name and the length of each information element are only examples, and are not limited thereto.

A PDU Type may indicate a structure of a PDU including PDU Set information, and an uplink type or a downlink type may be used as the PDU Type. A QFI indicates a QoS flow to which a corresponding PDU belongs. A PDU Set Info Exist (PSIE) indicates the presence or absence of PDU Set-related information, and may indicate the presence or absence of any PDU Set-related information described below. A PDU Set Size Exist (PSSizeE) indicates the presence or absence of a PSSize, and may indicate whether the PSSize is included or not. The PSSizeE may be used in the same meaning as a PDU Set Size Indicator (PSSI). That is, the PSSizeE and the PSSI may indicate whether the PSSize is included in the corresponding PDU or not.

An Indication of End PDU of the PDU Set (E) may indicate that a T-PDU is the last PDU in the PDU Set. The Indication of End PDU of the PDU Set (E) may be used in the same meaning as an End of PDU (EPDU).

When the RAN or the UPF receives the Indication of End PDU of the PDU Set (E) or the EPDU, the RAN or the UPF may calculate whether all PDUs for the corresponding PDU Set are received on the basis of the PSSize. In addition, in a situation in which the PSIHI indicates a False, when some PDUs in the corresponding PDU Set are lost, remaining PDUs in the corresponding PDU Set do not required to be received.

An EDB Exist (EDBE) may indicate the presence of the EDB. The end of data burst may be indicated by an EDB value without using the EDBE. The EDBE may be used in the same meaning as an End Data Burst Indicator (EDBI). According to an embodiment, the EDB may exist only when the EDBI is set to 1. That is, the EDBE and the EDBI may indicate whether the EDB is included or not in the corresponding PDU through a value of the EDBI.

The End of Data Burst Indication (EDB) may indicate that the corresponding T-PDU is the last of the data burst. According to an embodiment, the Data Burst may be composed of one or more PDU Sets. According to the configuration of the PDU Set, the data burst may be represented as one or more bursts and, accordingly, the end of each data burst may be represented as different values. In addition, according to an embodiment, the RAN may set a UE power management such as the DRX according to Data Burst information.

A PDU Set Importance (PSI) may indicate the importance of the PDU Set to which the T-PDU belongs. A PDU Set Sequence Number (PSSN) may indicate a serial number of the PDU Set to which the T-PDU belongs. A PDU Sequence Number within a PDU Set (PSN) may indicate the order of the T-PDU in the PDU Set to which the T-PDU belongs. A PDU Set Size in bytes (PSSize) indicates a size of the PDU Set, and may use 24 bits.

According to an embodiment, the PSI may indicate a relative importance of the PDU Set compared to other PDU Sets belonging to the corresponding QoS flow by the magnitude of a PSI value. For example, a smaller value may indicate higher importance.

In addition, according to an embodiment, a network may perform priority resource allocation and transmission on the basis of the PSI according to the importance of the PDU Set. For example, a packet having a lower importance may be discarded during a network congestion.

FIG. 15 is a view illustrating an example of extending a PDU Session User Plane Protocol, which is an example for transmitting uplink PDU Set-related information, according to an embodiment of the present disclosure.

Referring to FIG. 15, in FIG. 15, one or more of each information element illustrated in FIG. 14 may further be included, and such information elements may be added before a Padding, or an existing Spare and New IE Flags 1/2/3/4/5/6/7 may be utilized. The name and the length of each information element are only examples, and are not limited thereto.

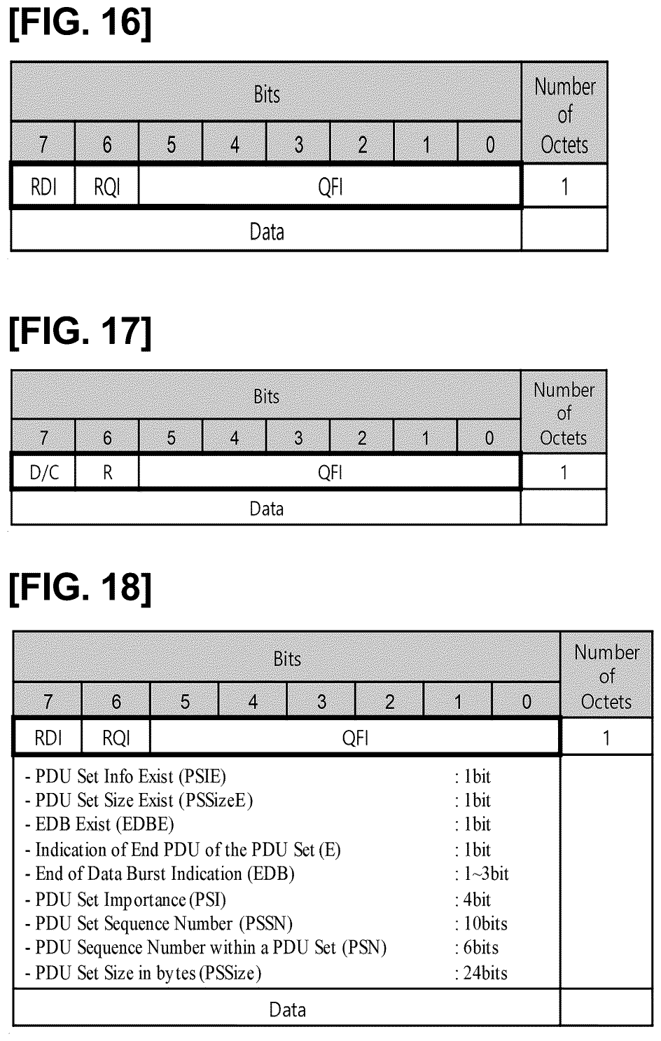

FIG. 16 is a view illustrating an example of a downlink header of a Service Data Adaptation Protocol (SDAP) for a data PDU from the RAN to the UE according to an embodiment of the present disclosure.

Referring to FIG. 16, an RDI may instruct on whether mapping of a QoS flow and a DRB to be updated. An RQI is a Reflective QoS Indicator, and may instruct the UE on whether to perform a Reflective QoS Activation. A QFI is a QoS Flow Identifier, and may indicate the QoS flow to which Data belongs. That is, according to an embodiment, the QFI may allow a QoS-based traffic to be processed on the basis of the QFI to which the PDU belongs.

FIG. 17 is a view illustrating an example of an uplink header of a Service Data Adaptation Protocol (SDAP) for a data PDU from the UE to the RAN according to an embodiment of the present disclosure.

Referring to FIG. 17, a D/C may indicate whether a PDU is a Data PDU or a Control PDU. An R may mean a Spare. A QFI is a QoS Flow Identifier, and may indicate the QoS flow to which Data belongs.

FIG. 18 is a view illustrating an example of extending a SDAP, which is an example for transmitting downlink PDU Set-related information, according to an embodiment of the present disclosure.

Referring to FIG. 18, in FIG. 18, one or more of each information element illustrated in FIG. 14 may further be included, and such information elements may be added before the Data field. The name and the length of each information element are only examples, and are not limited thereto.

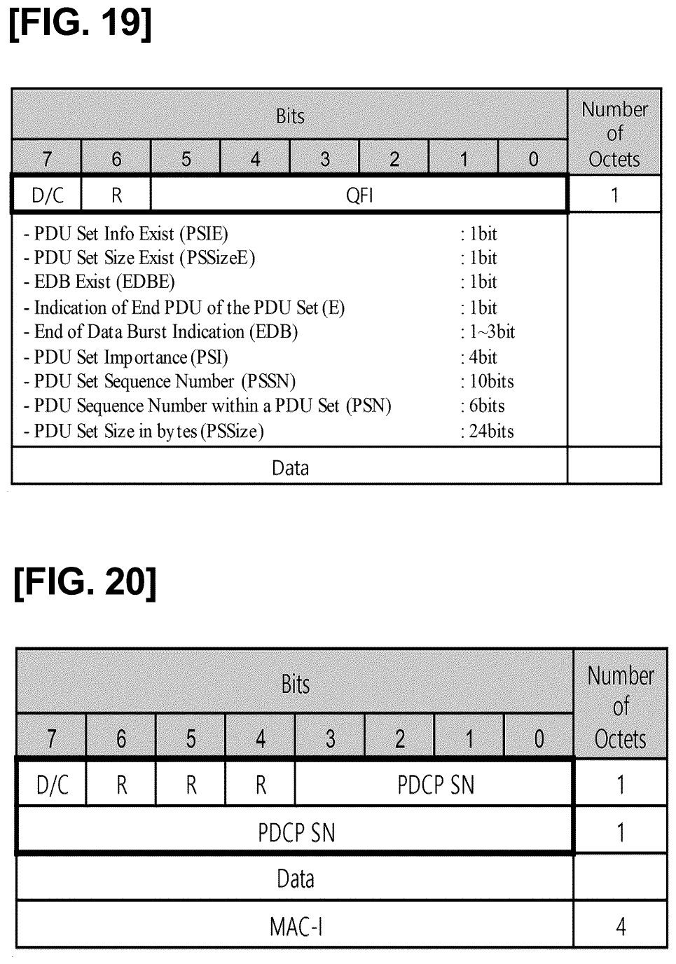

FIG. 19 is a view illustrating an example of extending a SDAP, which is an example for transmitting uplink PDU Set-related information, according to an embodiment of the present disclosure.

Referring to FIG. 19, in FIG. 19, one or more of each information element illustrated in FIG. 14 may further be included, and such information elements may be added before the Data field, or existing R bits may be utilized. The name and the length of each information element are only examples, and are not limiting.

FIG. 20 is a view illustrating an example of a Packet Data Convergence Protocol (PDCP) for a data PDU between the RAN and the UE according to an embodiment of the present disclosure.

Referring to FIG. 20, a D/C may indicate whether a PDU is a Data PDU or a Control PDU. An R may mean a spare. A PDCP SN is a PDCP sequence number, and may indicate a serial number of the PDCP. A MAC-I is a Message Authentication Code for Integrity, used to check the integrity of PDCP data, and may be optionally applied.

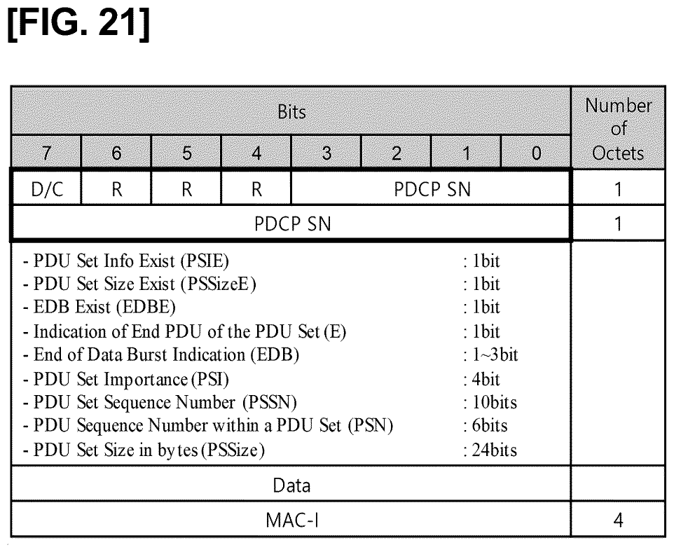

FIG. 21 is a view illustrating an example of extending a PDCP, which is an example for transmitting PDU Set-related information, according to an embodiment of the present disclosure.

Referring to FIG. 21, in FIG. 21, one or more of each information element illustrated in FIG. 14 may further be included, and such information elements may be added before the Data field. The name and the length of each information element are only examples, and are not limited thereto.

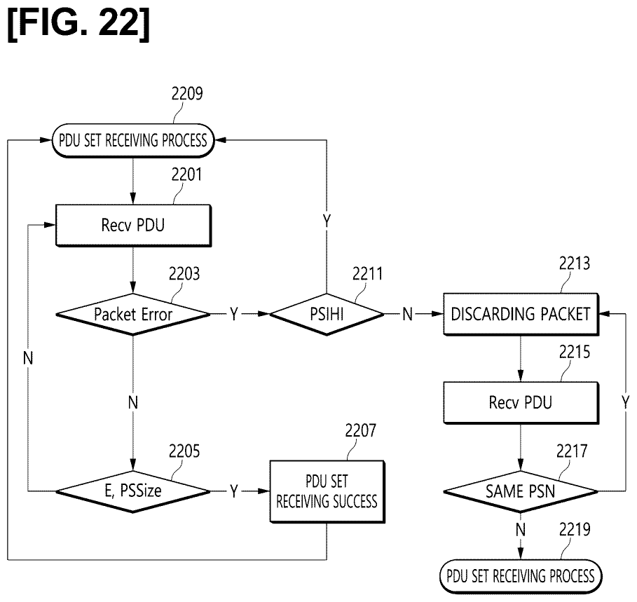

FIG. 22 is a view illustrating an example of a PDU set receiving process according to an embodiment of the present

Referring to FIG. 22, in the PDU set receiving process, a PDU may be received first (2201).

In response to the operation 2201, in the PDU set receiving process, whether there is an error may be checked (2203). In the operation 2203, both a situation in which a PDU with a required PSN and a required PSSN is not received within the time and a situation in which the received PDU contains an error may be considered as an error.

In a situation in which there is no error, when the E is set in the corresponding PDU and when the sum of the sizes of the PDUs that are already received has reached the PSSize (2205), it can be considered that all PDUs of the corresponding PDU set have been received (2207).

When the receiving of the corresponding PDU set is successful, the next PDU set may be received (2209).

In a situation in which there is an error, when the PSIHI is set (2211), packet receiving may be continued until all PDUs of the corresponding PDU Set are successfully received (2209).

In a situation in which there is an error, when the PSIHI is not set (2211), the PDU may be discarded and a new PDU is received, and then the new PDU is discarded when the new PDU has the same PSN as that of the discarded PDU. At this time, when a new PDU is received (2215) and the new PDU has a new PSN (2217), the corresponding PDU set receiving process (2219) may be continued. When a T-PDU belonging to another PDU Set having different PSSN is received, a new PDU set receiving process may be performed. In the PDU set receiving process, at least one or more PDU set receiving process(es) may be performed simultaneously for at least one or more PDU Set(s).

In summary, in the PDU set receiving process in FIG. 22, the PSIHI is considered according to PDU Set-related information obtained from the UE, the RAN, and the UPF for the downlink data and the uplink data. Furthermore, when PDUs belonging to one PDU Set according to the PDU Sequence Number within a PDU Set are not received for a predetermined time, other PDUs after the corresponding PSN may be discarded without waiting. To this end, the PSIHI, the PSSN, the PSN, and the EPDU may be used.

The RAN and the UE may use the PDU Set-related information to determine a DRX active time for power saving of the UE in consideration of the End of Data Burst.

According to the received PDU Set-related information, the RAN may perform resource scheduling for the QoS control about the PDU Set in consideration of the PSI, the PSER, and the PSDB. A Radio Bearer may be scheduled in consideration of the PDU Set Size.

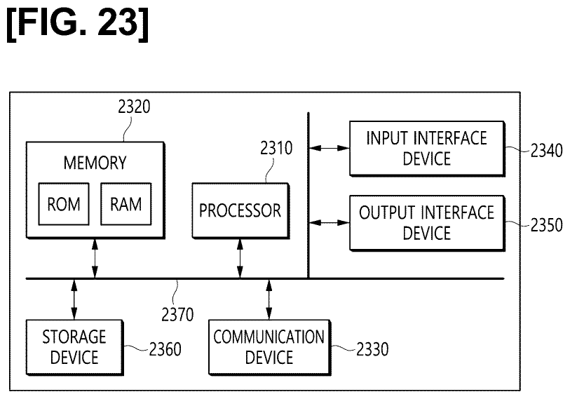

FIG. 23 is a view illustrating a configuration of an apparatus according to various embodiments of the present disclosure. Referring to FIG. 2, function elements of the 5G network (for example: the AF, the NEF, the PCF, the SMF, the AMF, the PSA UPF, and the Intermediate UPF) may include at least one of processor 2310, a memory 2320, and a communication device 2330 connected to the network and configured to perform communication. In addition, the function elements of the 5G network may further include an input interface device 2340, an output interface device 2350, a storage device 2360, and so on. Each component included in the function elements of the 5G network may be connected with each other by a bus 2370, and may communicate with each other.

However, each component included in the function elements of the 5G network may not be connected by the common bus 2370 and may instead be connected by individual interfaces or individual buses centered around the processor 2310. For example, the processor 2310 may be connected to at least one of the memory 2320, the communication device 2330, the input interface device 2340, the output interface device 2350, and the storage device 2360 through a dedicated interface.

The processor 2310 may execute a program command stored in at least one of the memory 2320 and the storage device 2360. The processor 2310 may mean a central processing unit (CPU), a graphics processing unit (GPU), or a dedicated processor in which methods according to embodiments of the present disclosure are performed. Each of the memory 2320 and the storage device 2360 may be configured as at least one of a volatile storage media and a non-volatile storage media. For example, the memory 2320 may be configured as at least one of a Read Only Memory (ROM) and a Random Access Memory (RAM).

According to various of embodiments the present disclosure, the present disclosure relates to a configuration in which the SMF provides PDU Set-related information to at least one of the UPF, the RAN, and the UE in a mobile communication network that includes the RAN, the UPF, the SMF, and the UE.

According to an embodiment, the PDU Set-related information that the SMF provides may include at least one of the PSSize, the PSI, the PSDB, the PSER, and the PSIHI.

According to an embodiment, the SMF may provide the PDU Set-related information to the UE by using any one of the PDUSessionModification command and the PDUSessionEstablishment req.

According to an embodiment, the SMF may provide the PDU Set-related information to the RAN by using any one of the PDUSessionResourceModify req Transfer and the PDUSessionResourceSetup req Transfer.

According to an embodiment, the SMF may provide the PDU Set-related information to the UPF by using any one of the PFCP_SesssionModification req and the PFCP_SesssionEstablishment req.

According to various embodiments of the present disclosure, the present disclosure relates to a configuration in which the UPF provides PDU Set-related information to the RAN or the RAN provides the PDU Set-related information to the UPF in a mobile communication network that includes the RAN, the UPF, the SMF, and the UE.

According to an embodiment, the present disclosure may provide the PDU Set-related information through the GTP-U.

According to an embodiment, the PDU Set-related information may include at least one of the PDU Type, the QFI, the PSSize, the PSSN, the PSN, the PSI, the EPDU, and the EODB.

The methods according to the embodiments of the present disclosure as described herein or in the following claims may be implemented as hardware, software, or a combination of hardware and software.

When the methods are implemented as software, a computer-readable storage medium storing one or more programs (for example, software modules) may be provided. The one or more programs stored in the computer-readable storage medium are configured for execution by one or more processors in an electronic device. The one or more programs include instructions directing the electronic device to execute the methods according to the embodiments of the present disclosure as described herein or in the following claims.

The programs (for example, software modules or software) may be stored in a non-volatile memory including a RAM or a flash memory, a ROM, an EEPROM, a magnetic disc storage device, a CD-ROM, a DVD, another optical storage device, or a magnetic cassette. Alternatively, the programs may be stored in a memory including a combination of some or all of the above-mentioned storage media. In addition, a plurality of such memories may be included.

In addition, the programs may be stored in an attachable storage device accessible through any or a combination of communication networks such as the Internet, an intranet, a LAN, a WAN, and a SAN. Such a storage device may access, via an external port, the electronic device that performs embodiments of the present disclosure. Furthermore, an additional storage device on the communication network may access the electronic device that performs embodiments of the present disclosure.

In the afore-described embodiments of the present disclosure, an element or elements included in the present disclosure are expressed in a singular or plural form according to the described embodiments of the present disclosure. However, the singular or plural form is selected appropriately for a situation assumed for convenience of description, the present disclosure is not limited to the singular or plural form, and an element expressed in a singular form may include a plurality of elements and elements expressed in a plural form may include a single element.

Specific embodiments of the present disclosure are described in the description of the present disclosure, but it will be understood that various modifications may be made without departing the scope of the present disclosure. Thus, the scope of the present disclosure is not limited to the embodiments described herein and should be defined by the appended claims and their equivalents.

What is claimed is:

1. A method for operating a User Plane Function (UPF) in a wireless communication system, the method comprising a process of transmitting Packet Data Unit (PDU) Set-related information and information for indicating the PDU Set-related information to a Radio Access Network (RAN) through a GTP-U extension header,
wherein the information for indicating the PDU Set-related information comprises a PDU type, a QoS Flow Identifier (QFI), a PDU Set Size Indicator (PSSI), an End Data Burst Indicator (EDBI), a PDU Set Sequence Number (PSSN), and a PDU Sequence Number within a PDU Set (PSN), and
the PDU Set-related information comprises at least one of an End PDU of the PDU Set (EPDU), an End of Data Burst (EDB), a PDU Set Importance (PSI), and a PDU Set Size (PSSize).

2. The method of claim 1, wherein the PDU type indicates a structure of a PDU, and the structure of the PDU is indicated according to uplink or downlink.

3. The method of claim 1, wherein the QFI is an identifier for a QoS flow to which a corresponding PDU and a corresponding PDU Set belong.

4. The method of claim 1, wherein the PSSI indicates whether the PSSize is included in a PDU.

5. The method of claim 1, wherein the EDBI indicates whether the EDB is included in a PDU.

6. The method of claim 1, wherein the EPDU indicates that a PDU is a last PDU in a corresponding PDU Set.

7. The method of claim 1, wherein the EDB indicates that a PDU is an end of a specific data burst.

8. The method of claim 1, wherein the PSI indicates an importance of a PDU Set to which a corresponding PDU belongs.

9. The method of claim 1, wherein the PSN indicates an order of a corresponding PDU included in a corresponding PDU Set.

10. The method of claim 1, wherein the PSSN indicates a serial number of a PDU Set in data flow.

11. The method of claim 1, wherein the PSSize indicates a total size of all PDUs belonging to a PDU Set to which a PDU belongs.

12. An apparatus for operating a User Plane Function (UPF) in a wireless communication system, the apparatus comprising:
a transceiver; and
a controller connected to the transceiver such that the controller is capable of being operated with the transceiver,
wherein the controller is configured to transmit Pack Data Unit Set-related information and information for indicating the PDU Set-related information to a Radio Access Network (RAN) through a GTP-U extension header, and
wherein the information for indicating the PDU Set-related information comprises a PDU type, a QoS Flow Identifier (QFI), a PDU Set Size Indicator (PSSI), an End Data Burst Indicator (EDBI), a PDU Set Sequence Number (PSSN), and a PDU Sequence Number within a PDU Set (PSN), and
the PDU Set-related information comprises at least one of an End PDU of the PDU Set (EPDU), an End of Data Burst (EDB), a PDU Set Importance (PSI), and a PDU Set Size (PSSize).

13. The apparatus of claim 12, wherein the PDU type indicates a structure of a PDU, and the structure of the PDU is indicated according to uplink or downlink.

14. The apparatus of claim 12, wherein the QFI is an identifier for a QoS flow to which a corresponding PDU and a corresponding PDU Set belong.

15. The apparatus of claim 12, wherein the PSSI indicates whether the PSSize is included in a PDU.

16. The apparatus of claim 12, wherein the EDBI indicates whether the EDB is included in a PDU.

17. The apparatus of claim 12, wherein the EPDU indicates that a PDU is a last PDU in a corresponding PDU Set.

18. The apparatus of claim 12, wherein the EDB indicates that a PDU is an end of a specific data burst.

19. The apparatus of claim 12, wherein the PSI indicates an importance of a PDU Set to which a corresponding PDU belongs.

20. The apparatus of claim 12, wherein the PSN indicates an order of a corresponding PDU included in a corresponding PDU Set, the PSSN indicates a serial number of the PDU Set in data flow, and the PSSize indicates a total size of all PDUs belonging to the PDU Set to which the PDU belongs.
